(19) United States
(12) Patent Application Publication
(10) Pub. No.: US 2007/0049217 A1
(43) Pub. Date: Mar. 1, 2007

(54) Electronic equipment connectable to external equipment

(75) Inventors: Yoshiho Suzuki, Kyoto City (JP); Yasushi Obata, Takatsuki City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/508,142

(22) Filed: Aug. 23, 2006

(30) Foreign Application Priority Data
Aug. 25, 2005 (JP) 2005-244111

(51) Int. Cl. H04B 1/38

(52) U.S. Cl. 455/90.3; 455/575.1; 455/128; 455/347; 379/330; 379/428.01

(57) ABSTRACT

In order to protect a connection portion for connecting to external equipment, a voice recording apparatus includes a main body case having a battery housing portion for housing a battery and a connection portion housing portion arranged in line with the battery housing portion, a base portion having a connection portion connectable to the external equipment fixed thereto and being supported on the main body case in such a manner as to be displaceable between a first position in which at least the connection portion is housed in the connection portion housing portion and a second position in which the connection portion is outside of the connection portion housing portion, and a cover which may open and close the battery housing portion and the connection portion housing portion when the connection portion is in the first position.

This application is based on Japanese Patent Application No. 2005-244111 filed with Japan Patent Office on Aug. 25, 2005, the entire content of which is hereby incorporated by reference.

### BACKGROUND OF THE INVENTION

1. Field of the Invention

The present invention relates to electronic equipment, and more particularly to electronic equipment connectable to external equipment.

2. Description of the Background Art

Recently, electronic equipment including a connection terminal for connecting to a personal computer becomes widespread for data communications with personal computers. Japanese Patent Laying-Open No. 2005-91409 discloses a voice recording apparatus including a first housing forming a main body portion, a second housing having one end portion coupled to the first housing pivotally to the first housing, a third housing having one end portion coupled to the second housing pivotally to the second housing around the axis of rotation orthogonal to the axis of rotation of the second housing with respect to the first housing, and a connection terminal provided at the other end portion of the third housing for use in connection with an external device.

However, the connection terminal is exposed outside when used without being connected to a computer, so that the connection terminal needs to be protected by any dustproof measures such as a dedicated cap that covers the connection terminal. Therefore, the attaching/removing operation of the dedicated cap is cumbersome. In addition, since the cap is separated from the main body during connection with a computer, the cap may be lost during use.

### SUMMARY OF THE INVENTION

The present invention is made to solve the aforementioned problem. An object of the present invention is to provide electronic equipment having a protected connection portion for connecting to external equipment.

In order to achieve the above-described objects, in accordance with an aspect of the present invention, electronic equipment includes: a main body case having a first housing portion for housing a battery and a second housing portion arranged in line with the first housing portion; a connection member having a connection portion connectable to external equipment and being supported on the main body case in such a manner as to be displaceable between a first position in which at least the connection portion is housed in the second housing portion and a second position in which the connection portion is outside of the second housing portion; and a cover which may open and close the first housing portion and the second housing portion when the connection member is in the first position.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1A is a front view of a voice recording apparatus.

FIG. 1B is a rear view of the voice recording apparatus.

FIG. 1C is a left side view of the voice recording apparatus.

FIG. 1D is a plan view of the voice recording apparatus.

FIG. 1E is a bottom view of the voice recording apparatus.

FIG. 2 is a cross sectional view taken along line A-A in FIG. 1A.

FIG. 3 is a cross sectional view taken along line B-B in FIG. 2.

FIG. 4 is a cross sectional view taken along line C-C in FIG. 2.

FIGS. 5A-5F illustrate a rotational operation of a connection portion of the voice recording apparatus.

FIG. 6 is a cross sectional view taken along line A-A of the voice recording apparatus where a cover is moved to a position where a connection portion housing portion is open.

FIG. 7 is a cross sectional view taken along line A-A of the voice recording apparatus where the cover is moved to a position where a battery housing portion is partially open.

FIG. 8 is a cross sectional view taken along line A-A of the voice recording apparatus where the cover is moved to a position where the battery housing portion is fully open.

### DESCRIPTION OF THE PREFERRED EMBODIMENT

In the following, an embodiment of the present invention will be described with reference to the figures. In the following description, the same parts will be denoted with the same reference characters. Their designations and functions are also the same. Therefore, detailed description thereof will not be repeated.

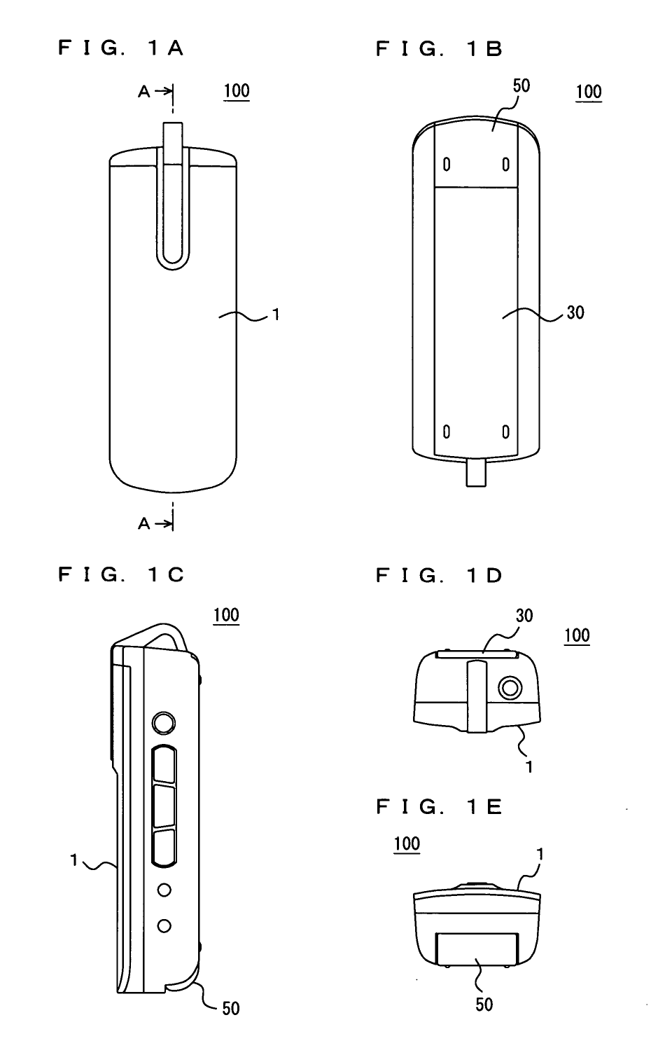

In the present embodiment, a voice recording apparatus will be described as an example of electronic equipment. FIGS. 1A-1E show the front view, rear view, left side view, plan view, and bottom view of a voice recording apparatus 100, respectively. Voice recording apparatus 100 includes a microphone so that voices picked up by the microphone are stored as electronic data in a semiconductor memory such as an integrated circuit (IC). Voice recording apparatus 100 includes an A/D (analog/digital) converter converting an analog voice signal picked up and output by the microphone into a digital signal, and a digital signal processor (DSP) processing the digital voice signal. The digital voice signal is stored in the IC memory. This IC memory may be removable from voice recording apparatus 100.

Furthermore, voice recording apparatus 100 has a communication function to receive and transmit data from/to a personal computer and the like. Therefore, voice recording apparatus 100 has a connection portion for connecting to a personal computer. Here, the connection portion is a USB (Universal Serial Bus) terminal. The voice recording apparatus can transmit a voice signal processed by DSP or a voice signal recorded in the IC memory to a personal computer connected through the USB terminal and also can receive a voice signal from a personal computer through the USB terminal for recording into the IC memory.

In addition, voice recording apparatus 100 includes D/A (digital/analog) converter, an amplifier and a speaker and has a reproduction function. Voice recording apparatus 100 processes a digital voice signal read from the IC memory at DSP, converts the processed digital voice signal into an analog signal at the D/A converter, and then amplifies the analog signal at the amplifier for output to the speaker. Therefore, a voice signal recorded in the IC memory is reproduced so that voices are output from the speaker.

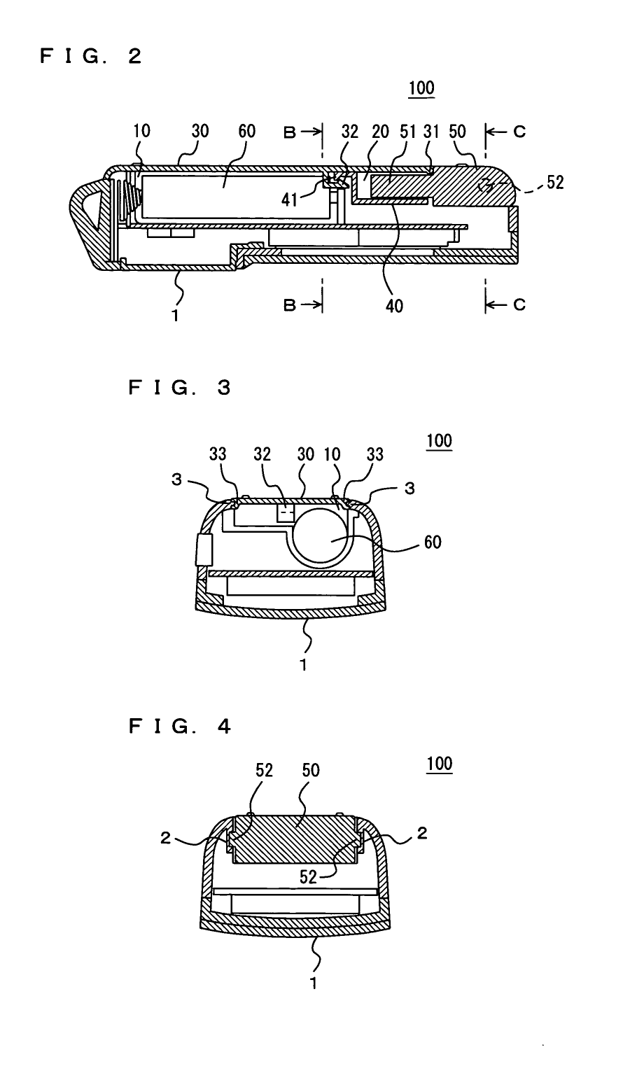

FIG. 2 is a cross sectional view taken along line A-A in FIG. 1A. FIG. 3 is a cross sectional view taken along line B-B in FIG. 2. FIG. 4 is a cross sectional view taken along line C-C in FIG. 2. Referring to FIGS. 2, 3 and 4, voice recording apparatus 100 includes a main body case 1, a cover 30 removable from main body case 1, a connection portion 51, and a base portion 50. Cover 30 is provided on the back face of voice recording apparatus 100. Main body case 1 includes a battery housing portion 10, which is open to the outside when cover 30 is removed from main body case 1, and a connection portion housing portion 20. Battery housing portion 10 can house a battery 60. Battery housing portion 10 and connection portion housing portion 20 are arranged in line in the longitudinal direction of main body case 1. A spacer wall 40 is provided between battery housing portion 10 and connection portion housing portion 20. Spacer wall 40 forms a part of the wall of connection portion housing portion 20, extends in the direction opposite to connection portion housing portion 20, and has a fixing portion 41 at one end, which protrudes toward the inside of the main body case.

Base portion 50 has a rotation shaft 52, which is pivotally supported by a bearing portion 2 of main body case 1. Therefore, base portion 50 can rotate with respect to main body case 1 about rotation shaft 52. Connection portion 51 is a USB convex terminal fixed to base portion 50. Connection portion 51 and base portion 50 constitute a connection member. Connection portion 51 is inserted into a USB concave terminal included in a personal computer or the like, whereby voice recording apparatus 100 is connected to the personal computer. FIG. 2 shows that connection portion 51 is housed in connection portion housing portion 20. Here, the position of connection portion 51 and base portion 50 as shown in FIG. 2 will be referred to as a first position. Connection portion 51 in the first position abuts on spacer wall 40 forming a part of the wall of connection portion housing portion 20. Therefore, spacer wall 40 restricts the movement of base portion 50 rotating in the counterclockwise direction in the figure about rotation shaft 52.

Cover 30 includes a restriction portion 31 protruding from the back surface of cover 30 (the main body case side) at an end portion on the connection portion housing portion 20 side. FIG. 2 shows that cover 30 is fully coupled to main body case 1. When cover 30 is fully coupled to main body case 1, battery housing portion 10 and connection portion housing portion 20 of main body case 1 are closed by cover 30 so that they are shielded from the outside of main body case 1. When cover 30 is fully coupled to main body case 1, restriction portion 31 of cover 30 abuts on connection portion 51. Therefore, restriction portion 31 restricts base portion 50 rotating in the clockwise direction in the figure about rotation shaft 52. Accordingly, when cover 30 is fully coupled to main body case 1, restriction portion 31 restricts free movement of connection portion 51 inside connection portion housing portion 20. It is noted that although here restriction portion 31 abuts on connection portion 51 by way of example, restriction portion 31 may abut on base portion 50. This can also restrict rotation of base portion 50. In any case, while cover 30 is fully coupled to main body case 1, restriction portion 31 needs to abut on the connection member formed of connection portion 51 and base portion 50.

Main body case 1 has two guide grooves 3 extending in the direction in which battery housing portion 10 and connection portion housing portion 20 are arranged in line. Cover 30 has an engaging projection 33 on each of two end faces thereof in the longitudinal direction. Engaging projection 33 of cover 30 is engaged with guide groove 3 of main body case 1. Therefore, cover 30 can move in the longitudinal direction of main body case 1 with engaging projection 33 being engaged with guide groove 3.

Cover 30 has a coupling portion 32 extending under fixing portion 41 of spacer wall 40 from the battery housing portion 10 side to the connection portion housing portion 20 side when cover 30 is entirely coupled to main body case 1. Coupling portion 32 has an approximately triangle-shaped end portion, which has a tip end portion such that the distance from cover 30 is gradually reduced from the connection portion housing portion 20 side to the battery housing portion 10 side. When cover 30 is positioned to be entirely coupled to main body case 1, the end portion of coupling portion 32 is positioned to the connection portion housing portion 20 side from fixing portion 41 of spacer wall 40 so that coupling portion 32 and fixing portion 41 are coupled to each other. Since the end portion of coupling portion 32 is positioned to the connection portion housing portion 20 side from fixing portion 41 of spacer wall 40, the movement of cover 30 from the connection portion housing portion 20 side to the battery housing portion 10 side is restricted. Therefore, when cover 30 is positioned to be entirely coupled to main body case 1, cover 30 is prevented from dropping from main body case 1.

Cover 30 is preferably formed of a resin or the like. With cover 30 positioned to be entirely coupled to main body case 1, when a force is applied from the outside of main body case 1 at that position of cover 30 which is opposed to fixing portion 41 of spacer wall 40, cover 30 flexes inwardly of main body case 1. Thus, coupling portion 32 is displaced according to the amount of flexion of cover 30, so that the coupling with fixing portion 41 is released. Therefore, cover 30 becomes movable in the direction from connection portion housing portion 20 to battery housing portion 10.

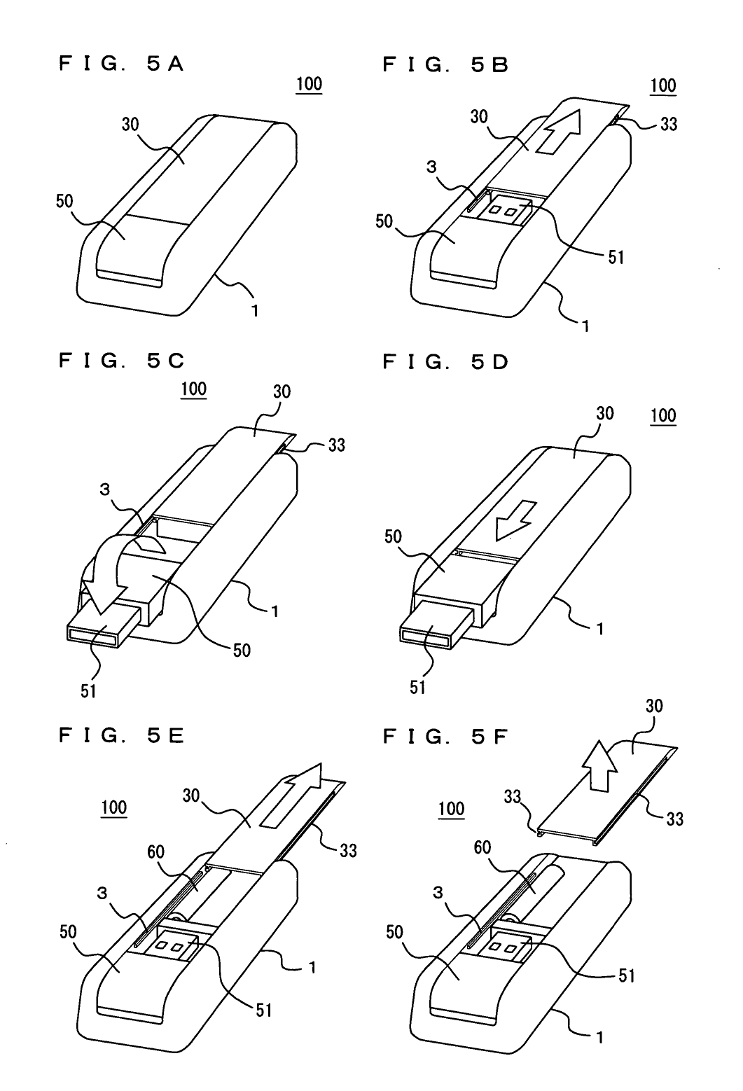

FIG. 5A is a perspective view of voice recording apparatus 100 as viewed from the back, with connection portion 51 housed therein. Connection portion 51 is positioned to be housed in connection portion housing portion 20, and cover 30 is positioned to close housing portion 10 and connection portion housing portion 20. The back face is formed of main body case 1, cover 30 and base portion 50 with less irregularities. Therefore, voice recording apparatus 100 can easily be accommodated in a clothing pocket or the like.

FIG. 5B is a perspective view of voice recording apparatus 100 as viewed from the back, where cover 30 is moved to a position in which connection portion housing portion 20 is open. Connection portion 51 is positioned to be housed in connection portion housing portion 20. Since cover 30 is moved to the position in which connection portion housing portion 20 is open, so that restriction portion 31 of cover 30 separates from connection portion 51. This allows connection portion 51 and base portion 50 to rotate outward of main body case 1.

FIG. 5C and FIG. 5D are perspective views of voice recording apparatus 100 as viewed from the back, where connection portion 51 and base portion 50 are rotated outward of main body case 1. FIG. 5C shows that cover 30 is moved to the position in which connection portion housing portion 20 is open, and FIG. 5D shows that cover 30 is moved to the position in which connection portion housing portion 20 is closed. After connection portion 51 and base portion 50 are rotated outward of main body case 1, cover 30 can be moved to the position in which connection portion housing portion 20 is closed. Therefore, after connection portion 51 and base portion 50 are rotated outside of main body case 1, cover 30 is fully coupled to main body case 1. Also in this state, coupling portion 32 of cover 30 is coupled to fixing portion 41 of the main body case.

FIG. 5E and FIG. 5F are perspective views of voice recording apparatus 100 as viewed from the back, where cover 30 is moved to the position in which connection portion housing portion 20 and battery housing portion 10 are open. Since battery housing portion 10 is opened, battery 60 can be removed from or housed into main body case 1.

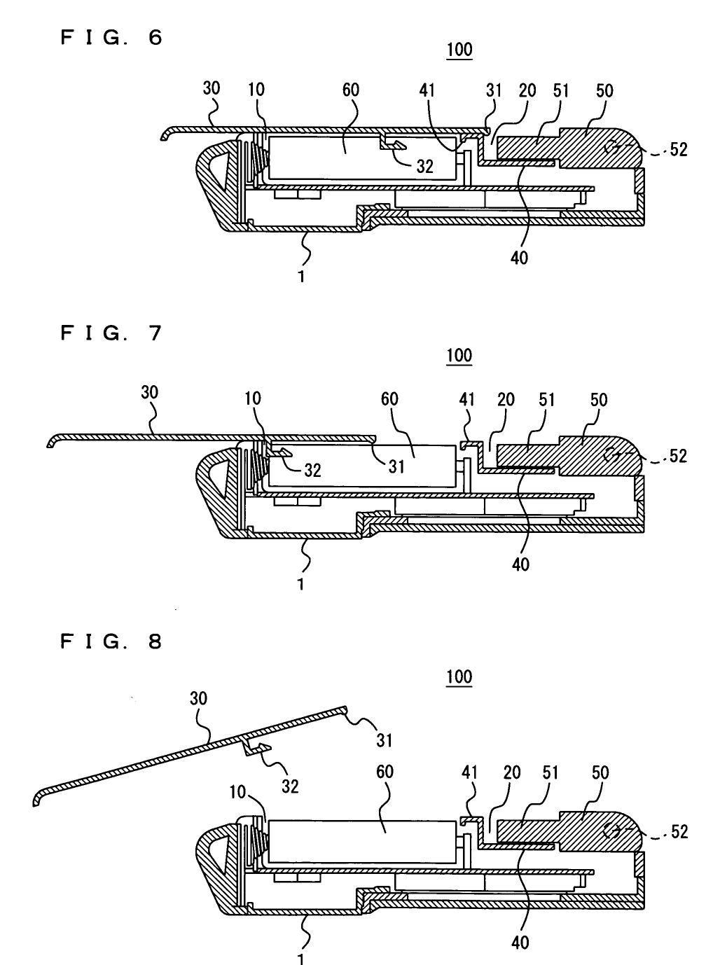

FIG. 6 is a cross sectional view of voice recording apparatus 100 taken along line A-A, where cover 30 is moved to the position in which connection portion housing portion 20 is open. Cover 30 is moved from the position in which connection portion housing portion 20 is closed, in the direction from connection portion housing portion 20 side to the battery housing portion 10 side. When cover 30 is moved from the position in which connection portion housing portion 20 is closed to the position in which connection portion housing portion 20 is open, restriction portion 31 of cover 30 is brought into abutment with spacer wall 40 provided to main body case 1. Thus, a force is exerted to prevent the movement of cover 30. Cover 30 is formed of a resin and thus elastic, so that with application of a great force on cover 30 in the direction in which it moves, cover 30 becomes deformed outward of main body case 1 thereby releasing the restriction of restriction portion 31 by spacer wall 40. This allows cover 30 to move, and with the movement of cover 30, restriction portion 31 gets over spacer wall 40. When cover 30 is further moved, battery housing portion 10 is opened.

FIG. 7 is a cross sectional view of voice recording apparatus 100 taken along line A-A, where cover 30 is moved to the position in which battery housing portion 10 is partially open. In FIG. 7, engaging projection 33 of cover 30 is still engaged with guide groove 3 of main body case 1.

FIG. 8 is a cross sectional view of voice recording apparatus 100 taken along line A-A, where cover 30 is moved to the position in which battery housing portion 10 is entirely open. In FIG. 8, engaging projection 33 of cover 30 is no longer engaged with guide groove 3 of main body case 1, so that cover 30 is detached from main body case 1.

As described above, in voice recording apparatus 100 in the present embodiment, when connection portion 51 is housed in connection portion housing portion 20, cover 30 closes connection portion housing portion 20, so that connection portion 51 is shielded from the outside by cover 30. This prevents connection portion 51 from being soiled with dirt or dust or damaged by an external great force.

In addition, since base portion 50 having connection portion 51 fixed thereto is rotatably supported on main body case, connection portion 51 can be directed outward of main body case 1 with an easy operation of rotating base portion 50 with respect to main body case 1.

Moreover, main body case 1 has guide groove 3 extending in the direction in which battery housing portion 10 and connection portion housing portion 20 are arranged in line, so that cover 30 is moved by guiding engaging projection 33 in engagement with guide groove 3 of main body case 1. Therefore, cover 30 is movable in the direction in which battery housing portion 10 and connection portion housing portion 20 are arranged in line, so that connection portion housing portion 20 can be open while battery housing portion 10 is kept closed.

In addition, cover 30 has restriction portion 31 in abutment with spacer wall 40. Therefore, if cover 30 is moved from the position in which connection portion housing portion 20 is closed, the movement of the cover is restricted when cover 30 reaches the position where battery housing portion 10 is closed and connection portion housing portion 20 is open. Thus, only connection portion housing portion 20 can easily be opened by moving cover 30.

Furthermore, when cover 30 is positioned such that battery housing portion 10 and connection portion housing portion 20 are closed, restriction portion 31 abuts on connection portion 51 housed in connection portion housing portion 20 to restrict the rotation of base portion 50. Therefore, the free movement of connection portion 51 inside connection portion housing portion 20 is restricted, and connection portion 51 can be fixed.

In addition, when cover 30 is positioned such that battery housing portion 10 and connection portion housing portion 20 are closed, coupling portion 32 is coupled to fixing portion 41 provided at main body case 1. Therefore, cover 30 can be fixed to main body case 1.

Moreover, when connection portion 51 is outside of connection portion housing portion 20, cover 30 closes battery housing portion 10 and connection portion housing portion 20, so that battery housing portion 10 and connection portion housing portion 20 can be closed while connection portion 51 is connected to a personal computer or the like, thereby preventing cover 30 from sticking out of main body case 1.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. Electronic equipment comprising:
a main body case having a first housing portion for housing a battery and a second housing portion arranged in line with the first housing portion;
a connection member having a connection portion connectable to external equipment and being supported on said main body case in such a manner as to be displaceable between a first position in which at least said connection portion is housed in said second housing portion and a second position in which said connection portion is outside of said second housing portion; and
a cover which may open and close said first housing portion and said second housing portion when said connection member is in said first position.

2. The electronic equipment according to claim 1, wherein said connection member is rotatably supported on said main body case.

3. The electronic equipment according to claim 1, wherein
said main body case has a guide portion extending in a direction in which said first housing portion and said second housing portion are arranged in line, while said cover has an engagement portion to be engaged with said guide portion, and
said engagement portion is guided in engagement with said guide portion whereby said cover is moved.

4. The electronic equipment according to claim 3, wherein
said main body case has a wall portion for dividing said first housing portion from said second housing portion, and
said cover has a restriction portion coming into abutment with said wall portion when said cover reaches a position in which said first housing portion is closed and said second housing portion is open from a position in which said first housing portion and said second housing portion are closed.

5. The electronic equipment according to claim 4, wherein said restriction portion restricts a free movement of said connection member in said second position when said cover is in a position in which said first housing portion and said second housing portion are closed.

6. The electronic equipment according to claim 3, wherein
said main body case has a wall portion dividing said first housing portion from said second housing portion and having a coupled portion, and
said cover has a coupling portion which may be coupled to said coupled portion in a position in which said first housing portion and said second housing portion are closed.

7. The electronic equipment according to claim 1, wherein said cover may open and close said first housing portion and said second housing portion when said connection member is in said second position.
